(19) United States
(12) Patent Application Publication
(10) Pub. No.: US 2008/0065428 A1
(43) Pub. Date: Mar. 13, 2008

(54) Automated Campground System

(76) Inventor: Tyler Duffy, Mount Juliet, TN (US)

Correspondence Address: TYLER DUFFY, 1054 STONEHOLLOW WAY, MOUNT JULIET, TN, 37122, US

(21) Appl. No.: 11/470,663

(22) Filed: Sep. 7, 2006

(51) Int. Cl. G06Q 10/00

(52) U.S. Cl. 705/5

(57) ABSTRACT

This invention automates the check in process of campgrounds and allows for amenities to be distributed to the clients without the help of campground personal. By controlling the dispersal of amenities, the invention prevents clients from using the campground amenities without making payment.

### CROSS REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Currently, when a customer arrives at a campground, they have to check in at an office or with a campground representative. This can be a problem if the customer arrives outside of normal operating hours or in campgrounds that do not have a full time attendant. Often campgrounds or campsites are used and amenities such as electricity, water, and sewer access are distributed and never paid for.

1. Field of the Invention

The said invention relates to the problem described above allowing the customer to check in automatically without the assistance of a campground representative. Check in and payment are achieved via the automated campground system and amenities are distributed automatically for the said period of time.

2. Description of Prior Art

Currently there is no invention that automates or regulates the dispersal of amenities at campgrounds.

### BRIEF DESCRIPTION OF DRAWINGS

FIG. 1 displays a Terminal (TML)-Control Unit (CU) combination unit.

FIG. 2 is a block diagram of the CU.

FIG. 3 is a block diagram of the TML.

FIG. 4 is a block diagram of a Single TML System.

FIG. 5 is a block diagram of the Automated Campground System

### DESCRIPTION OF DRAWINGS

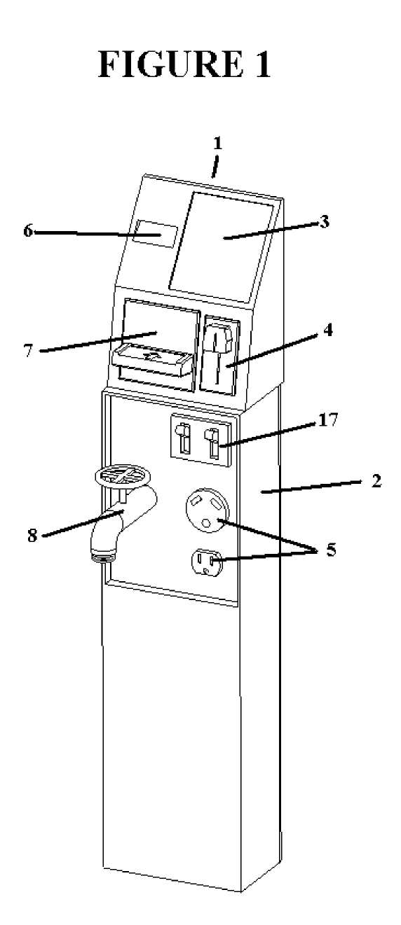

FIG. 1 is a representation of a Control Unit (CU) Terminal (TML) combination unit. A CU (2) is located wherever amenities are distributed because it controls the dispersal of the said amenities. The TML (1) is the main user interface with the customer. A combination unit is a package that attaches the TML (1) to the CU (2) for the convenience of the customer, thus allowing the customer to access the TML (1) upon arriving at the specific campsite. In this figure the TML (1) contains the following items on the exterior of its housing: a touch screen interface (3), a printer (6), a cash dispersal device (7), and a credit card reader (4). In this figure the CU (2) contains the following items on the exterior of the housing: electrical outlets (5), circuit breakers (17), and an outdoor water faucet (8).

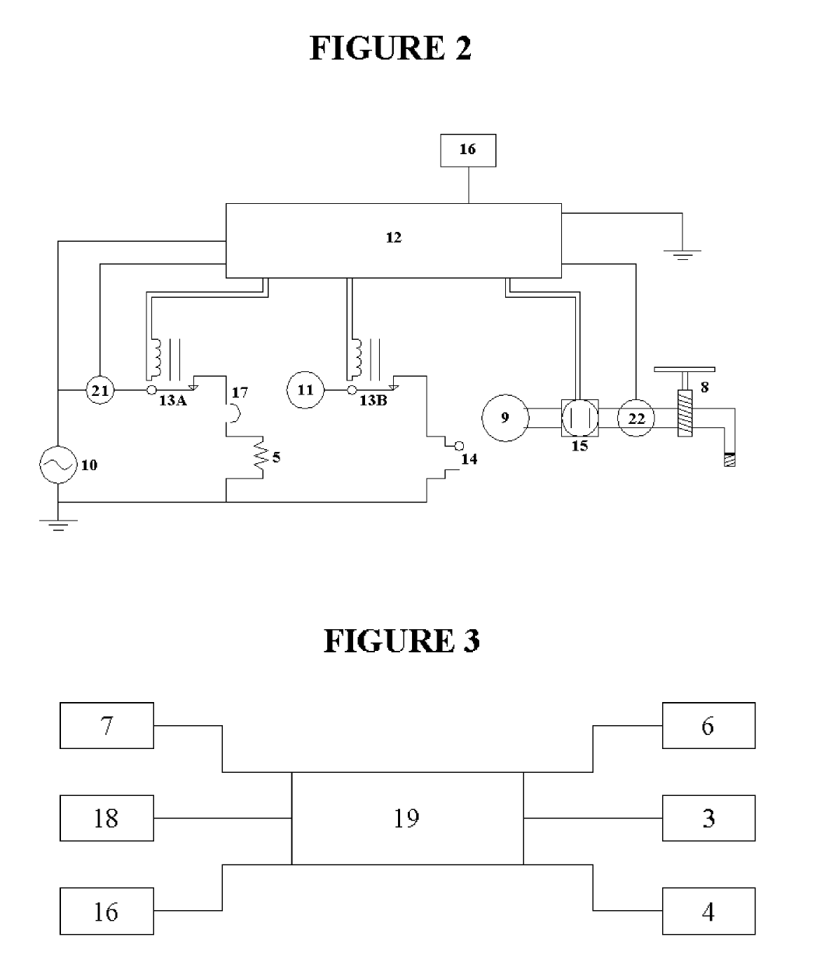

FIG. 2 is a block diagram of the CU. The CU contains the said items necessary for turning on and off amenities based upon a signal from the TML. The CU is controlled by a processor (12). The Processor is powered by an A/C power source (10) which also is the power/electricity for the attached RV via the electrical outlets (5). The power source for the RVs is controlled via a relay (13A) and has an inline circuit breaker (17). The relay (13A), circuit breaker (17), and electrical outlet (5) can be duplicated for multiple outlets where the need for 50 amp, 30 amp, 20 amp, and/or 15 amp outlets arises. The processor also controls a relay (13B) that controls optional sources (11) which are output at connection (14). Optional source (11), relay (13b), and connection (14) can be duplicated where the need for additional optional sources occur. Optional sources (11) may include, but are not limited to: phone, internet, and cable TV. Also attached to the processor (12) is a networking unit (16). The networking unit (16) uses internet networking technology to connect to other TML's and CU's via the campground intranet.

Also attached to the processor (12) is an electro mechanical valve/servo (15) that controls the dispersal of the water source (9). Inline with the water source is a mechanical water valve (8) located outside of the CU housing and accessible to the user.

In the case of long term users of the automated campground system the need to bill utilities separately may occur. The CU can measure utilities and provide usage data to the campground or campsite owner for the purpose of billing separately. This allows for the host of the campground to bill the customers separately for water and electricity without requiring the utility company to install a watt meter and change over the power to a customer's name. The automated campground system accomplishes utility billing with a watt meter (21) and water flow meter (22). These devices measure the utilities used by the specific customer and report the data to the CU processor (12), which in turn reports it to the TML, which in turn reports this information to the online database where it can be accessed via the internet by computers or TMLs.

FIG. 3 is a TML block diagram. The TML controls the functions of the CU and is comprised of the following: A cash payment receptacle (7), a cash change dispersal device (18), a networking unit (16), a printer (6), a touch screen monitor (3), and a magnetic card reader (4). The printer (6) can be used to print the details of the sales transaction as well as security codes for internet access or other information as needed. The touch screen/monitor (3) is the main interface with the customer. Credit and Debit card transactions can take place via the magnetic card reader (4).

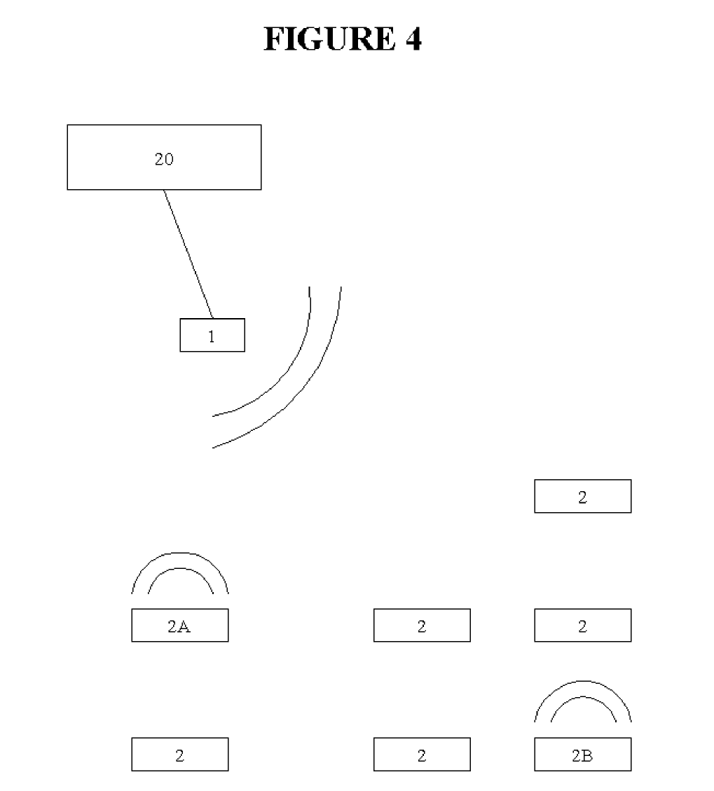

FIG. 4 is a block diagram of a Single Terminal System. In a Single Terminal System the TML (1) is located in a convenient location where it can be seen upon entry into the campground, in a central office, or where it can be accessed easily by multiple users. The TML (1) sends signals to the multiple CUs (2) under its control via wired or wireless signals. The block diagram shows an example of the TML communicating with two CUs (2A & 2B) at the same time. This type of scenario may occur when someone is checking into a unit (2A) while the said time limit has occurred for someone else in another unit (2B) and the amenities are being turned off. The TML sends the appropriate signals to the CUs to turn on the amenities in (2A) and turn off the amenities in (2B). The TML (1) is also connected to the online database (20) for the purpose of data back up and electronic financial transactions.

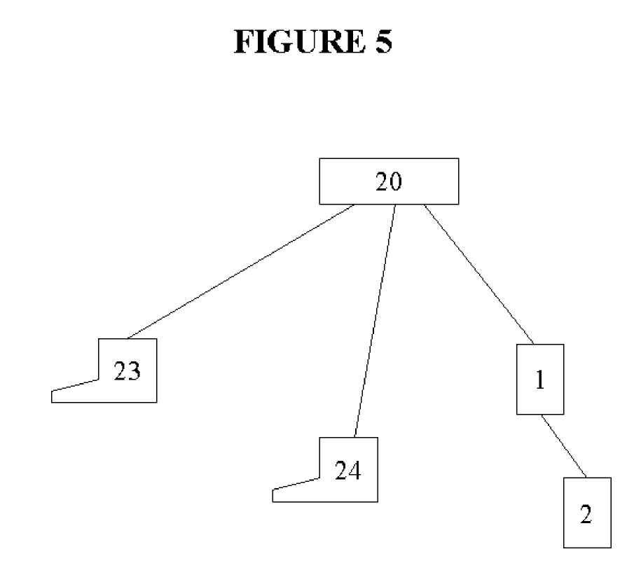

FIG. 5 is a block diagram of the Automated Campground system and the online database (20). There are three locations where payment, reservation, and data exchange can be made. These three locations include the following: a personal computer at home that is connected to the internet (23), the office/business computer/property management system at the campground (24), and the TML (1) located at the campground or point of use. The TML (1) is the only device that connects to the CU (2).

1-14. (canceled)

15. An automated campground amenity control system, comprising: a control unit managing a plurality of campsite amenities; and a terminal operably connected to the control unit and having an interface capable of detecting an authorization event with authorization data so that when the authorization event occurs the terminal can instruct the control unit to change the operation of at least one of the plurality of amenities according to the authorization data.

16. The system of claim 15, further comprising a networking unit coupled to the terminal wherein the networking unit allows the terminal to be accessed over a communication network.

17. The system of claim 16, further comprising a database coupled to the communication network so that the networking unit provides the terminal with access to the database through the communication network.

18. The system of claim 15, further comprising a measuring module operably connected to the control unit so that the measuring module can record usage data for the plurality of amenities.

19. The system of claim 18 wherein the interface has a screen and is coupled to the measuring module so that the interface can display the usage data on the screen.

20. The system of claim 15 wherein the authorizing event comprises at least one of a campsite reservation, administrative action, and a payment transaction, and wherein the authorizing data comprises information directed at which of the plurality of amenities is authorized for activation.

21. The system of claim 15 wherein the interface comprises a card reader.

22. An automated campground amenity control system, comprising: a control unit; a terminal coupled to the control unit and adapted to receive and authorize transactions; and one or more campground amenities operably associated with the control unit so that when the terminal receives an authorized transaction, the terminal informs the control unit causing the control unit to activate at least one of the one or more amenities.

23. The system of claim 22, further comprising: a networking unit connected to the terminal; and a database coupled to the networking unit allowing duplex communication between the terminal and the database.

24. The system of claim 25 wherein the networking unit comprises a wireless transceiver.

25. The system of claim 22, further comprising a power failure module coupled to the control unit so that in the event of a power failure the operation of the one or more amenities will remain unchanged.

26. The system of claim 8, further comprising an amenities recorder operably engaged to the one or more amenities and capable of monitoring and logging the amenities usage.

27. The system of claim 15, further comprising a printer connected to the terminal for the purpose of printing transaction and amenity usage data.

28. The system of claim 12, further comprising a billing unit engaged to the amenities recorder so that the billing unit can provide usage data for each of the one or more amenities.

29. A method for authorizing the dispersal of amenities at a campground, comprising the steps of: receiving a transaction request for the dispersal of one or more campground amenities; verifying the transaction request is authorized; and dispersing the one or more campground amenities in accordance with the authorized transaction request.

30. The method of claim 29, further comprising: communicating information about the transaction request to a user through a display.

31. The method of claim 29, further comprising: providing a communication network so that a user may conduct the transaction request from a remote site.

32. The method of claim 29, further comprising: recording usage characteristics of each of the one or more campground amenities as the amenities are dispersed.

33. The method of claim 29, further comprising: maintaining the dispersal of the one or more campground amenities during a power failure.

34. The method of claim 29, further comprising: providing a plurality of campground amenity dispersal sites; and connecting the plurality of sites so that a terminal can control the operation of the plurality of sites.
